(19) United States
(12) Patent Application Publication
(10) Pub. No.: US 2022/0340218 A1
(43) Pub. Date: Oct. 27, 2022

(54) WIDE BASE TRACK LINK

(71) Applicant: Epiroc Drilling Solutions, LLC, Garland, TX (US)

(72) Inventors: Erik Vipond, Rockwall, TX (US); James Hannah, Garland, TX (US)

(21) Appl. No.: 17/727,127

(22) Filed: Apr. 22, 2022

Related U.S. Application Data
(60) Provisional application No. 63/178,027, filed on Apr. 22, 2021.

(51) Int. Cl. B62D 55/20; B62D 55/26

(52) U.S. Cl. CPC B62D 55/20; B62D 55/26

(57) ABSTRACT

A track chain link includes a front side and a rear side with a distance therebetween and a base having a width. The base is coupled to an end of the front side and a corresponding end of the rear side. The width of the base is greater than the distance between the front side and the rear side. The base includes at least one extension having a combined length equal to the difference between the width of the base and the distance between the front side and the rear side. The at least one extension may be positioned beyond the front side of the track chain link. A track chain assembly includes the track chain link coupled to a track shoe. At least a portion of the base of the track chain link engages the track shoe.

### CROSS-REFERENCE TO RELATED APPLICATIONS

This application claims priority to, and the benefit of, U.S. Provisional Patent Application Ser. No. 63/178,027 filed Apr. 22, 2021, and entitled “Wide Base Track Link,” the disclosure of which is incorporated herein by reference in its entirety.

### TECHNICAL FIELD

This disclosure relates to a track chain link for a track shoe and endless track chain assembly for tracked vehicles, and is particularly suitable for work vehicles such as earth working machines, drilling machines, agricultural machines, and vehicles used in rough terrain generally.

### BACKGROUND

Ground-engaging endless track chain assemblies have long been employed to provide ground contact for vehicles used in construction, mining, logging, and other demanding off-road pursuits. Typical track shoes employed in such assemblies comprise a plate with single, double, or triple grousers, or cleats, running across its width to increase traction, and track chain links moveably connecting the track shoes with each other. It is well known, however, that higher traction track shoes tend to create more wear and tear on undercarriage components in such skid-steer vehicles, because of resistance to sideways forces and the torsional forces generated when the track is turning. In the past, engineers worked with track suppliers to improve the bolted joint holding a track chain link to a track shoe by increasing the size of the bolts used and shortening the track shoes to reduce the forces on the track shoes and therefore on the bolted joints. These are the common methods recommended by suppliers to address the issue of bolts loosening. What is needed is a better and simpler way to reduce the forces in the bolted joint to properly clamp the track shoe to the track chain link. The disclosure of U.S. patent application Ser. No. 16/884,275, titled “Track Shoe And Track Assembly For Tracked Vehicles”, filed May 27, 2020 is incorporated into this disclosure in its entirety, but is not admitted to be prior art by its inclusion in this background section.

### SUMMARY

The present disclosure relates to apparatus and methods for improving the connection between a track chain link and a track shoe.

In various implementations, a track chain link of the present disclosure comprises a base having a width that is greater than the distance between a front side and a rear side of the track chain link. The base may be coupled to corresponding ends of the front side and the rear side of the track chain link. A top may be coupled to the front side and the rear side of the track chain link, opposite the base. At least a portion of the track chain link may be formed from heat treated steel.

In various implementations, the base includes at least one extension having a combined length that is equal to the difference between the width of the base and the distance between the front side and the rear side of the track chain link. The at least one extension may be positioned beyond the front side, beyond the rear side, or beyond both the front side and the rear side of the track chain link.

In another aspect, a track chain assembly of the present disclosure comprises a track shoe coupled to the track chain link of the present disclosure. In various implementations, the track chain link and the track shoe may be coupled via bolts, or the track chain link and the track shoe may be formed as a unitary, one piece design. At least a portion of the base of the track chain link may engage the track shoe. In one implementation, the at least one extension of the base of the track chain link engages the track shoe.

In yet another aspect, a tracked vehicle of the present disclosure comprises the track chain link of the present disclosure. In various implementations of the tracked vehicle, the at least one extension of the base of the track chain link may be positioned beyond the front side, beyond the rear side, or beyond both the front side and the rear side of the track chain link. The tracked vehicle may be selected from the group consisting of: an earth working machine, a construction machine, a drilling machine, a logging machine, and an agricultural machine.

In still another aspect, a tracked vehicle of the present disclosure comprises the track chain assembly of the present disclosure. In various implementations of the tracked vehicle, the track chain link and the track shoe may be coupled via bolts, or the track chain link and the track shoe may be formed as a unitary, one piece design. At least a portion of the base of the track chain link may engage the track shoe. In one implementation, the at least one extension of the base of the track chain link engages the track shoe. The tracked vehicle may be selected from the group consisting of: an earth working machine, a construction machine, a drilling machine, a logging machine, and an agricultural machine.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 is a side view of a track chain link showing the improvement.

FIG. 2 is a side view of an improved track chain link affixed to a track shoe.

FIG. 3 is a perspective view of an improved track chain link.

FIG. 4 is a perspective view of a plurality of the improved track chain links connecting track shoes.

Like reference symbols in the various drawings indicate like elements.

### DETAILED DESCRIPTION

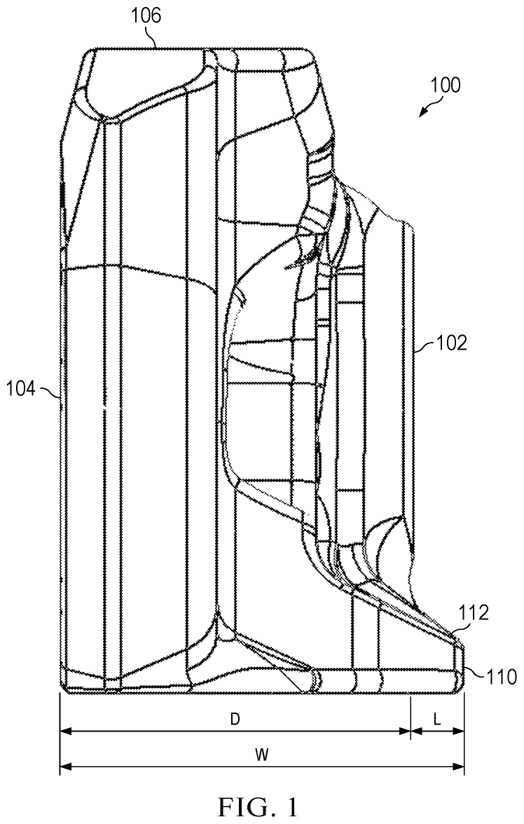

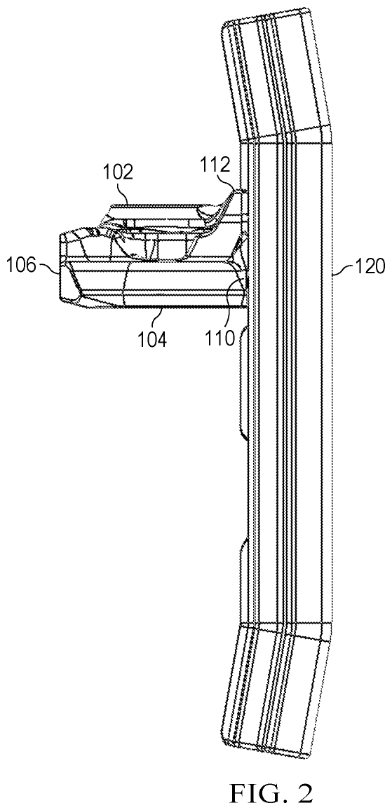

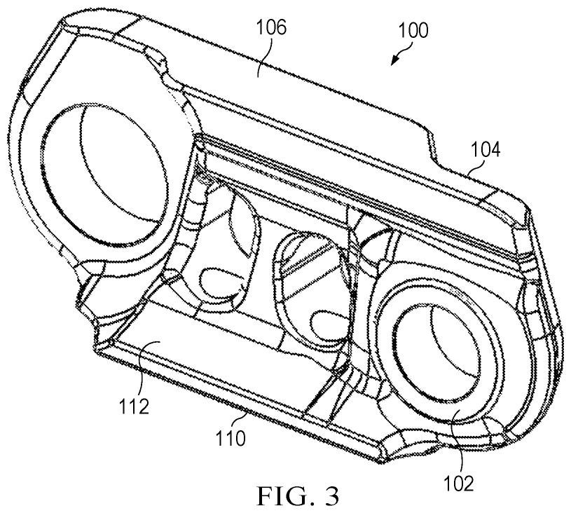

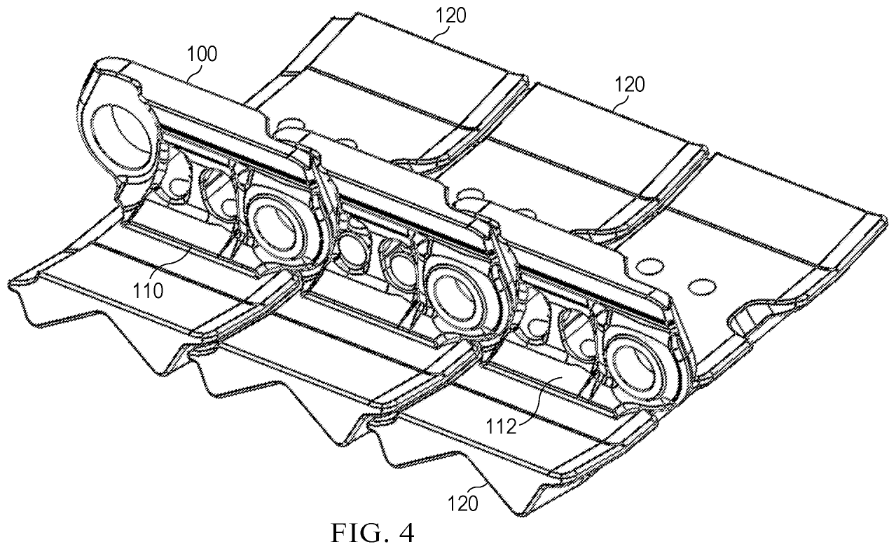

Referring to FIG. 1 and FIG. 3, a track chain link 100 of the present disclosure comprises a front side 102 and a rear side 104 separated by a distance D, a top 106, and a base 110 with a width W, the base 110 including at least one extension 112 having a combined length L. Referring to FIG. 2, a track chain assembly of the present disclosure comprises a track shoe 120 coupled to the track chain link 100 such that at least a portion of the base 110 engages the track shoe 120. In some implementations, the at least one extension 112 engages the track shoe 120. Referring to FIG. 4, in a representative track chain 200, a plurality of track chain links 100 are shown coupled to track shoes 120.

In some implementations of a track chain assembly of the present disclosure, track shoes 120 may be coupled to track chain links 100 via bolts. To address a common issue of such track shoe bolts (not shown) loosening and high stresses in the track shoe 120 at the interface with the track chain link 100, the base 110 of the track chain link 100 of the present disclosure includes at least one extension 112 that widens the base 110 beyond at least one side 102, 104 of the track chain link 100. As best shown in FIG. 1. and FIG. 2, in one implementation, the track chain link 100 of the present disclosure includes at least one extension 112 positioned to widen the base 110 beyond the front side 102 of the track chain link 100. In other implementations, a track chain link of the present disclosure may include at least one extension that widens the base beyond the rear side of the track chain link, or beyond both the front side and the rear side of the track chain link.

Widening the base of the track chain link with at least one extension introduces an advantage for the bolted joint by effectively reducing the required clamping force of the fasteners. It reduces the stress in the track shoe 120 as it effectively shortens the lever arm from the track chain link 100 to the outside of the track shoe 120, thereby allowing the track chain link 100 to distribute some of the load typically taken by the track shoe 120. In reducing the lever arm and therefore the moment in the track shoe 120, the bending or deflection of the track shoe 120 is also reduced, further reducing the likelihood that the track shoe 120/track chain link 100 interface will slip, which may cause the bolts to loosen.

In some implementations, the track chain link 100 will be manufactured either by forging or by casting using various grades of steel, which will typically be heat treated. As best shown in FIG. 1, the base 110, where the track chain link 100 interfaces with the track shoe 120, includes at least one extension 112 having a combined length L that widens the base 110 to a width W that is larger than the width of a parallel-sided link, i.e. the width W may be any width larger than the greatest distance D between the front side 102 and the rear side 104 of the track chain link 100. The wider the base 110, the higher the benefit for the bolted joint and the reduction of stresses in the track shoe 120. The limitation to the width W of the base 110 will be manufacturing processes. The key description is a base 110 that includes at least one extension 112 making the width W of the base 110 wider than the widest part, or greatest distance D, between the front side 102 and the rear side 104 of the main body of the track chain link 100. The width W is measured at the base 110 of the track chain link 100 where the track chain link 100 couples to the track shoe 120. As best shown in FIG. 2, the at least one extension 112 of the base 110 may extend only on one side of the track chain link 100, such as on the front side 102 of the track chain link 100, on the outside of the track chain link 100. The best or preferred way to use the improvement of a wide base 110 will be on any tracked machine which uses a design where a track shoe 120 is bolted to a track chain link 100.

An alternate version could be a unitary design which incorporates the track shoe 120 and the track chain link 100 into one piece. This would eliminate the bolted joint, but the effect on stress in the track shoe 120 and the track chain link 100 would be the same.

One advantage this improvement provides is the reduction of forces required in the bolted joint to properly clamp the track shoe 120 to the track chain link 100 to keep the bolted joint interface from slipping. A traditional track chain link does not have an extended base, thus increasing the force and stress on the bolted joint and the track shoe 120. Another advantage is the reduction of stress in the track shoe 120 itself when compared to other designs currently available.

It is to be understood that implementations of the present disclosure are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

1. A track chain link comprising:
a front side and a rear side with a distance therebetween; and
a base having a width;
wherein the base is coupled to an end of the front side and to a corresponding end of the rear side; and
wherein the width of the base is greater than the distance.

2. The track chain link of claim 1, wherein the base includes at least one extension having a combined length equal to the difference between the width of the base and the distance.

3. The track chain link of claim 2, wherein the at least one extension is positioned beyond the front side.

4. The track chain link of claim 2, wherein the at least one extension is positioned beyond the rear side.

5. The track chain link of claim 1, wherein at least a portion of the track chain link is formed from heat treated steel.

6. The track chain link of claim 1, further comprising:
a top coupled to the front side and to the rear side;
wherein the top is positioned opposite the base.

7. A track chain assembly comprising:
a track shoe coupled to the track chain link of claim 2.

8. The track chain assembly of claim 7, wherein:
the track shoe is coupled to the track chain link via bolts.

9. The track chain assembly of claim 7, wherein:
the track shoe and the track chain link are formed as a unitary, one-piece design.

10. The track chain assembly of claim 7, wherein:
at least a portion of the base of the track chain link engages the track shoe.

11. The track chain assembly of claim 7, wherein:
the at least one extension of the base of the track chain link engages the track shoe.

12. A tracked vehicle comprising the track chain link of claim 2.

13. The tracked vehicle of claim 12, wherein the at least one extension is positioned beyond the front side.

14. The tracked vehicle of claim 12, wherein the tracked vehicle is selected from the group consisting of: an earth working machine, a construction machine, a drilling machine, a logging machine, and an agricultural machine.

15. A tracked vehicle comprising the track chain assembly of claim 7.

16. The tracked vehicle of claim 15, wherein:
the track shoe is coupled to the track chain link via bolts.

17. The tracked vehicle of claim 15, wherein:
the track shoe and the track chain link are formed as a unitary, one-piece design.

18. The tracked vehicle of claim 15, wherein:
at least a portion of the base of the track chain link engages the track shoe.

19. The tracked vehicle of claim 15, wherein:
the at least one extension of the base of the track chain link engages the track shoe.

20. The tracked vehicle of claim 15, wherein the tracked vehicle is selected from the group consisting of: an earth working machine, a construction machine, a drilling machine, a logging machine, and an agricultural machine.
